(19) United States
(12) Patent Application Publication
(10) Pub. No.: US 2007/0216747 A1
(43) Pub. Date: Sep. 20, 2007

(54) Light source calibration and adjustment for scanning printer

(75) Inventors: Brian E. Blair, Raleigh, NC (US); Tuyen Bui, Morrisville, NC (US); Robert T. Cato, Raleigh, NC (US); Robert A. Myers, Cary, NC (US); Ravinder Prakash, Concord, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/376,044

(22) Filed: Mar. 15, 2006

(51) Int. Cl. B41J 2/385

(52) U.S. Cl. 347/132

(57) ABSTRACT

A scanning printer including a scanner unit having an adjustable scanning light output may be adjusted by determining a minimum response for each pixel and a maximum response for each pixel when scanning a calibration document and setting the light output to correlate to a maximum response value. The scanner unit may include a reference plate for internal and routine performance adjustments which include comparison of initial and operational response to the reference plate. Performance adjustments may be designed to account for and overcome various typical operational problems encountered with frequent use.

### TRADEMARKS

IBM 8 is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to scanning printers and particularly to calibration of LED and CCD therein.

2. Description of Background

A CCD contact scanner can be used for various image capture functions. Often, the scanner includes multiple light-emitting diode (LED) elements for illumination as well as a device for sensing light. Typically, the sensing device is a charge coupled device (CCD). Each CCD includes a number of pixels for sensing the illumination. Typically, the LED elements and the CCD circuit elements have a wide tolerance in light output and sensitivity, respectively. One problem with use of LED elements is that LEDs have a tendency to degrade with use. In one example, the useful life of the LED elements in a scanner is about 700 hours.

What is needed is a technique for maximizing the performance of a scanner using LED elements and pixel elements. Preferably, the technique provides for calibration and compensation that accounts for initial or lifetime variations in the LEDs and pixel elements. Also, it is preferred that the technique be effective at time of manufacture or subsequent repair. The technique should also provide for maximizing the available video range so that standard image processing algorithms can be used more effectively.

### SUMMARY OF THE INVENTION

Disclosed is a method for adjusting a light source, the method including selecting a scanning unit having at least one lighting element as the light source and a plurality of pixels for sensing the light source and further having a capability for adjusting an output of the at least one lighting element; setting a minimum response value for at least one to all of the pixels when the at least one lighting element is set to a minimum output; sampling a calibration standard for developing a representative response value for each pixel and adjusting the output of the at least one lighting element upward until at least one pixel reaches a maximum output during the sampling; and, adjusting the output of the at least one lighting element downward until a subset of the at least one pixel is less than the maximum output during the sampling and then determining a maximum response value for each pixel.

Also disclosed is a computer program product stored on machine readable media and having instructions for adjusting a light source that includes at least one lighting element, by instructions that include selecting a scanning unit having the at least one lighting element and a plurality of pixels and further having a capability for adjusting an output of the at least one lighting element; setting a minimum response value for each pixel when the at least one lighting element is set to a minimum output; sampling a calibration standard for developing a representative response value for each pixel and adjusting the output of the at least one lighting element upward until at least one pixel reaches a maximum output during the sampling; and, adjusting the output the at least one lighting element downward until a subset of the at least one first pixel is less than the maximum output during the sampling and then setting a maximum response value for each pixel.

Further disclosed is a scanner including a computer program product stored on machine readable media including instructions for adjusting an internal light source having at least one lighting element, by instructions for setting a minimum response value for each pixel in a plurality of pixels when the at least one lighting element is set to a minimum output, the plurality of pixels for receiving output light from the at least one lighting element; sampling a calibration standard for developing a representative response value for each pixel and adjusting the output of the at least one lighting element upward until at least one pixel reaches a maximum output during the sampling; and, adjusting the output of the at least one lighting element downward until a subset of the at least one pixel is less than the maximum output during the sampling and then setting a maximum response value for each pixel.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

The technical effect of the present invention is that a computer program product stored on machine readable media and having instructions for adjusting a light source that includes at least one lighting element, is provided and includes instructions for selecting a scanning unit having the at least one lighting element and a plurality of pixels and further having a capability for adjusting an output of the at least one lighting element; setting a minimum response value for each pixel when the at least one lighting element is set to a minimum output; sampling a calibration standard for developing a representative response value for each pixel and adjusting the output of the at least one lighting element upward until at least one pixel reaches a maximum output during the sampling; and, adjusting the output of the at least one lighting element downward until a subset of the at least one pixel is less than the maximum output during the sampling and then setting a maximum response value for each pixel.

The instructions may further include instructions for saving at least one of the minimum response value and the maximum response value for each pixel; referencing a reference plate and determining an initial representative response value for routine adjusting; using an algorithm for determining; maintaining a compensation table for each pixel, determining a compensation value for each pixel; performing routine adjusting by scanning the reference plate and determining an operational representative response value, comparing the operational representative response value to the initial representative response value; and, alternatively, and one of adjusting the output of the at least one lighting element one of upward and downward and not adjusting the output of the at least one lighting element; determining the minimum response value; and, determining the maximum response value.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a printer;

FIG. 2 illustrates one example of a scanner within the printer;

FIG. 3 illustrates one example of a process for calibration and adjustment of the scanner;

FIG. 4 illustrates one example of scanner response for the calibrated scanner; and;

FIG. 5 illustrates one example of a grey reference plate with contamination thereon.

The detailed description explains the preferred embodiments of the invention, together with advantages and features, by way of example with reference to the drawings.

### DETAILED DESCRIPTION OF THE INVENTION

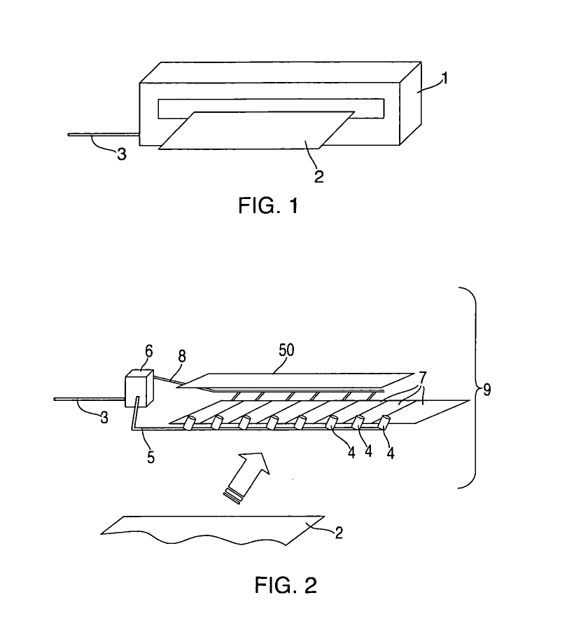

Referring to FIG. 1, there are shown to aspects of printer 1. In the illustration provided, the printer 1 includes scanning functions. A document for scanning, referred to as a “scan sheet 2” is fed into the printer 1. The printer 1 is powered by a power supply 3 that provides current and voltage. As used herein, the scan sheet 2 is generally synonymous with and may be referred to as a “document,” as a “target” and as a “calibration standard.”

Referring to FIG. 2, there are shown aspects of a scanning unit 9 for the printer 1. In the embodiment illustrated, the scanning unit 9 (also referred to as a scanner 9) includes an array of LEDs 4 and an array of pixels 7. Typically, the array of pixels 7 is provided as elements of a charged coupled device (CCD). Although discussed herein as using a CCD, this embodiment is non-limiting. For example, it should be recognized that other similar devices such as a complementary metal-oxide-semiconductor device (CMOS) may be used.

It should be recognized that the scanning unit 9, or scanner 9, may be used in any one or more of a variety of devices. For example, the scanner 9 may be employed in at least one of a bed scanner, a scanning printer, a hand-held scanner, a point-of-sale device and a process device. Exemplary point-of-sale devices include devices used for recognition and authentication of currency and other documents. Exemplary process devices include commercial and industrial devices such as might be useful for process controls such as mail sorting. Accordingly, one skilled in the art will appreciate that the scanner 9 may be included in a great variety of devices where scanners are typically used.

The array of LEDs 4 provides illumination of the target to be scanned by the array of pixels 7. In typical embodiments, the array of LEDs 4 operates as a single source of light. However, in some embodiments, the array of LEDs 4 includes separately controllable LEDs 4. As discussed herein, the array of LEDs 4 operates as the light source, wherein a single power supply provides for energizing the light source. However, other embodiments may be realized. In some embodiments, each LED includes a separate power supply. In some other embodiments, illumination is provided by lighting elements other than LEDs 4. Accordingly, one skilled in the art will recognize that the aspects of the array of LEDs 4 as discussed herein is not limiting of the teachings regarding the light source, and therefore merely illustrative.

The array of LEDs 4 is coupled to an electronics unit 6 via an LED bus 5. The electronics unit 6 includes components as appropriate or desired for driving the array of LEDs 4. The array of pixels 7 in the CCD are likewise coupled to the electronics unit 6 via a pixel bus 8. In typical and non-limiting embodiments, the CCD includes a linear array of pixels 7 (that is, a single line of pixels 7). In some other embodiments, the CCD includes other configurations of pixels 7. Scan sheets 2 typically travel on a paper path through the scanner 9 in the direction indicated by the arrow in FIG. 2.

The scanner 9 also includes a grey reference plate 50. The grey reference plate 50 is included for system quality checks as described further herein. In some embodiments, the CCD (i.e., the pixels 7) and the array of LEDs 4 are movable and generally translate along the paper path. In typical embodiments, and as discussed herein, the CCD and LEDs are stationary and the scan sheet 2 is moved.

Exemplary components within the electronics unit 6 include at least one analog to digital converter (ADC), memory, a processing unit (or processor) and other components as are known in the art.

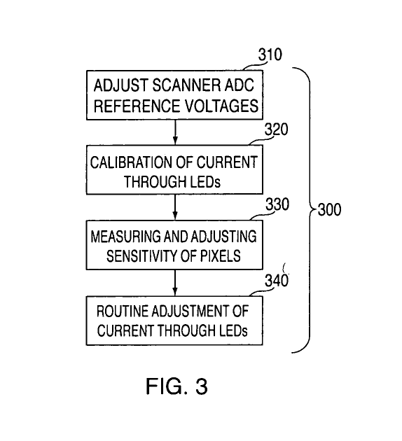

FIG. 3 depicts a calibration procedure 300 for calibration of the scanner 9 that that generally include four parts. The first part calls for adjustment to analog to digital converter (ADC) reference voltages in a stage referred to as adjusting voltage 310. The second part calls for calibration of current traveling through light emitting diodes (LEDs) in a stage referred to as calibrating LED current 320. The third part calls for the sensitivity of the individual pixels to be measured and calibrated, in a stage referred to as sensitivity adjusting 330. The fourth part calls for routine adjustment of the current traveling through the LEDs in a stage referred to as adjusting LED current 340.

The first stage, adjusting voltage 310, is described in a separate technical article entitled “Digitally Controlled Dual Reference Circuit,” dated Aug. 20, 2004 and incorporated herein by reference in it's entirety. This document is available in the prior art database at www.ip.com. As an overview, a discussion of certain relevant aspects of adjusting voltage 310 is now provided, in combination with a review of aspects of the scanner 9.

Each pixel 7 of the scanner 9 provides an analog signal representing the amount of light received. The analog signal is used as an input to the ADC, which in turn feeds a digitized video signal representative of the analog signal to the processor. Among other things, the digital value produced by the ADC is dependent on the reference voltages provided to the ADC. In typical embodiments, the reference voltages used by the ADC are fixed at a given value.

However, in some embodiments of scanners 9, the processor is provided with a capability for adjusting the reference voltages over an entire operational range (i.e., from “off” (where the ADC output value is hex “00”) to “saturation” (where the ADC output value is hex “FF”) for a particular analog input voltage.). As voltage adjusting 310 is not a part of the present application, it is mostly important to note that this capability usually permits the processor to control and maximize a usable dynamic range for the digitized video signal. Typically, and as used herein, a “black” target provides a minimum digitized video signal, while a “white” target provides a maximum digitized video signal. The “black” target may be correlated to LEDs that are turned off.

The second stage, calibrating LED current 320, calls for adjusting the current through the LEDs 4. The third stage calls for the determining the sensitivity of the individual pixels 7 to be measured and then calibrating them. Sensitivity adjusting 330 for the pixels 7 provides uniform video output when using a target having uniform emissivity, such as the calibration target.

Typically, the calibration document is used to adjust the current directed to the LEDs 4 and to determine the light sensitivity of each pixel 7 of the scanner 9. The LED current is adjusted in order to insure that the amplitude of the digitized video signal from a known white target is as large as possible. If too much LED current is used, the digitized video signal from the ADC will not adequately describe differences between values for white targets, light grey targets, and possibly even darker targets. As one might surmise, too much LED current may result in lost information. In instances where too much LED current is used, the digitized video signal is typically assigned a value of “FF” (as expressed in hexadecimal notation).

Stated another way, avoiding saturation of each pixel 7 is desired. Typically, saturation of a single pixel 7 occurs when aspects such as the LED current are set high enough to overwhelm the capacity of the pixel 7. If saturation occurs, distinctions between features on documents being scanned may be lost or less than desired. However, one skilled in the art will recognize that it is sometimes advantageous to allow a predetermined number of pixels 7 to saturate. It should also be recognized that in some embodiments, it is advantageous that no pixels 7 are saturated. Therefore, a maximum output is selected according to the needs of a system design. In typical embodiments, the maximum output is the output where the pixel 7 reaches saturation. However, the teachings herein are not limited to embodiments where pixels are related to saturation. That is, the maximum output, which may or may not correlate to saturation, is typically determined by a system designer.

Further, and in regard to calibrating LED current 320, it should be recognized that although adjusting the output of the LEDs (i.e., at least one lighting element) upward causes at least one pixel (i.e., a set of pixels 7) to reach maximum output, that adjusting the output of the LEDs downward does not require a perfect correlation within the pixels 7. For example, in one embodiment, while adjusting the output of the LEDs upward, about ten percent of the pixels 7 in the array of pixels 7 reach maximum output at the same LED current. When adjusting the LED current downwards it may be desired to leave some portion, or a subset, of the pixels 7 (for example, about one percent) at maximum output. One skilled in the art will recognize that the subset may include none to all of the pixels previously set to maximum output.

One advantage of the teachings herein is that calibration of the LED current, the pixel sensitivity, and referencing of the associated grey reference plate 50 occurs at the same time. The function of the grey reference plate 50 is described below.

The fourth stage, adjusting LED current 340, involves use of a grey reference plate 50. Typically, the grey reference plate 50 is fabricated from plastic. However, other suitable materials may be used. The grey reference plate 50 is mounted within the printer 1 and is used as a target for performing routine adjustment of the LED current. Reading the grey reference plate 50 provides data for a determination of a representative pixel value. Typically, the representative pixel value substantially corresponds to the LED current established during calibrating LED current 320. Typically, the representative pixel value is an average, however, other techniques may be used (some of which are discussed further herein).

The stage of adjusting LED current 340 calls for routine adjustment of the LED current. Advantageously, the adjusting LED current 340 does not require any human intervention and is tolerant of a reasonable amount of dirt and ink contamination (e.g., amounts of dirt and ink contamination as might be encountered with moderate to heavy use of the printer 1). Thus, adjusting LED current 340 can be performed automatically each time the printer 1 is powered up and periodically during the operation of the printer 1.

Typically, the reference plate 50 is grey in appearance. This appearance permits software used for finding the edge of the check to operate more efficiently. Advantageously, the grey color has a smaller difference in reflectivity from dirt and ink than a white target. Thus, the grey target is more tolerant to dirt and ink contamination than a white color target. In addition, saturation of the pixels 7 is less likely when observing a grey surface. However, the other colors or appearances of the reference plate 50 may be had. Therefore, the color grey is merely illustrative of the appearance of the reference plate 50 and not limiting. An exemplary illustration of an appearance for the grey reference plate 50 is provided in FIG. 5.

As discussed above, the adjusting voltage 310 stage is described in a separate publication. Therefore, adjusting voltage 310 for the ADC reference voltage is not discussed further and calibrating LED current 320 is now discussed in greater depth.

An exemplary embodiment for calibrating LED current 320 includes a series of steps. Calibrating LED current 320 initially calls for use of a calibration standard having a known reflectivity and a known uniformity. Typically, a white document is used as the calibration standard. Once the calibration standard is inserted into the scanner 9 of the printer 1, calibrating LED current 320 commences.

Although the term “calibration standard” is used herein, this should not be taken to mean specific controls, color temperatures or other such standards are applied to the calibration standard. For example, the calibration standard may include a blank piece of white paper drawn from a supply used for printing thereon. Accordingly, it should be understood that the term “calibration standard” contemplates a calibration document selected and deemed suitable for calibration.

As a first step in calibrating LED current 320, the LED current value is set to a lowest possible value. Then, the calibration standard is moved along the paper path of the printer 1 until the calibration standard is staged at the scanner 9. The scanner 9 then commences scanning of the calibration standard and collects data for each pixel 7 in the CCD. Each response value is saved as a data point. The calibration standard is then incrementally advanced along the paper path. Each pixel 7 is sampled again, and the response value is again saved. The process for sampling, saving and advancing is repeated a desired number of times and produces a data set of response values for each pixel 7. Typically, the number of times is chosen to provide for reliable statistical determinations using the saved data set for each pixel 7. Using this process, multiple samples are taken for each pixel 7, each at a different location on the calibration standard. Once a desired number of samples have been collected, the data for each pixel 7 are typically averaged to establish a representative value. Averaging is employed to reduce the effect of any variations in the calibration document, such as the calibration document not having uniform reflectivity (techniques other than averaging may also be employed as deemed suitable).

The representative response value for each pixel 7 is then compared against the maximum response value that is desired for each pixel 7. This maximum response value typically represents saturation or a value of one less than saturation for the pixel 7. In one embodiment, the maximum response value that can be read by a pixel 7 is “FF” (as expressed in hexadecimal notation). In another embodiment, the maximum response value that is desired for a pixel 7 is “FE” (as expressed in hexadecimal notation), in order to guarantee that the pixel 7 is not saturated.

If none of the pixels 7 have their maximum allowed response value (at or near saturation), the LED current is then adjusted incrementally upward. Adjusting the LED current incrementally upward typically calls for another sampling, saving and advancing routine. Alternatively, the data from the first sampling, saving and advancing may be used for the adjusting the data set for each pixel 7 incrementally upward through extrapolation using a response model for characteristics of the LEDs 4. Incremental adjustment is repeated until one or more representative response values for one or more of the pixels 7 in the CCD has reached a maximum response value. Typically, the maximum response value is the value when saturated or near saturation. The LED current is then lowered until the representative response value for one or more of the pixels 7 in the array is below the maximum response value. As soon as one or more of the pixels 7 are below the maximum response value, the reference voltage for the ADCs and the LED current are set. Setting the reference voltage and the LED current in this manner assures that a maximum dynamic range is provided for the digitized video signal. In other words, the difference between the digitized video signal for one or more of the pixels 7 surveying a black area and the digitized video signal for the pixel 7 surveying a white area is maximized. Using this technique, one or more of the pixels 7 will have a digitized video signal that has a linear response for the actual light received. Typically, the pixel 7 scanning a black area will have a response value expressed of at least “01” while the pixel 7 scanning a white area will have a response value at or below “FE” (where the values are expressed in hexadecimal notation).

Once the reference voltages for the ADC and the LED current have been set (i.e., calibrated), the calibration values are saved.

Although disclosed herein in terms of reference voltage for the at least one ADC and LED current for the light source, it should be understood that these devices are non-limiting examples used for illustration of the techniques herein. That is, in other embodiments, the light source having lighting elements other than LEDs may be used. While the actual requirements or techniques for adjusting the performance of these other light sources may differ in some respects from those discussed herein, these other light sources are within the contemplation and teachings herein. Accordingly, it should be considered that adjusting of reference voltages and LED current are among the various resources available for maximizing performance as discussed herein and merely illustrative.

The representative (typically average) response value for each pixel 7 is also saved. Typically, the calibration values and the representative response values are saved in nonvolatile memory. The representative response value for each pixel 7 is typically saved for use with other processes. For example, in one embodiment, the representative response value for each pixel 7 is used to compensate for scanned image quality variations arising from variations between each of the pixels 7.

Once the calibration values have been saved, the calibration standard is then moved from a view of the scanner 9, so that the scanner 9 has an unobstructed view of the reference plate 50. In other embodiments, other aspects of the scanner 9 are moved to provide the unobstructed view of the reference plate 50.

With the LED current set to the calibration value and the scanner 9 aligned with the reference plate 50, sampling of the grey reference plate 50 for each pixel 7 commences. Once the grey reference plate 50 has been sampled, the grey response value for each pixel 7 is similarly saved. The grey response value typically is the average value of multiple samplings of the image of reference plate 50.

A single grey response value is then generated for all of the pixels 7. The single grey response value is typically generated via use of an algorithm operating in software. The single grey response value is selected to represent the amount of light reflected by the reference plate 50 and is correlated to the calibration value for the LED current. For convenience, the single grey response value is referred to as an “initial LED adjustment value.” Once established, the initial LED adjustment value is typically saved in nonvolatile memory. As one skilled in the art might surmise, a variety of algorithms may be employed for determining the single grey response value.

A non-limiting example of an algorithm for producing the single grey response value includes an algorithm for averaging the grey response value for each of the pixels 7. Another example includes an algorithm that averages the grey response value for each pixel 7 after a preliminary review and rejection of data from certain pixels 7. Rejection might be used for those pixels 7 having significantly different grey response values (on the basis that significantly different values are probably due to the scanning of dirt, ink or other foreign matter), or for other reasons. For example, the preliminary review and rejection may be based on predetermined values, another statistic, such as a group statistical test or through other techniques deemed suitable.

Another exemplary algorithm involves creating a histogram of the pixel grey response values. The single grey response value produced by the algorithm is the most commonly observed value (i.e., the mode) from a scan of the reference plate 50. The most commonly observed value is represented by the highest peak in the histogram. As another example, the algorithm uses a weighted average of grey response values near the highest peak in the histogram peak.

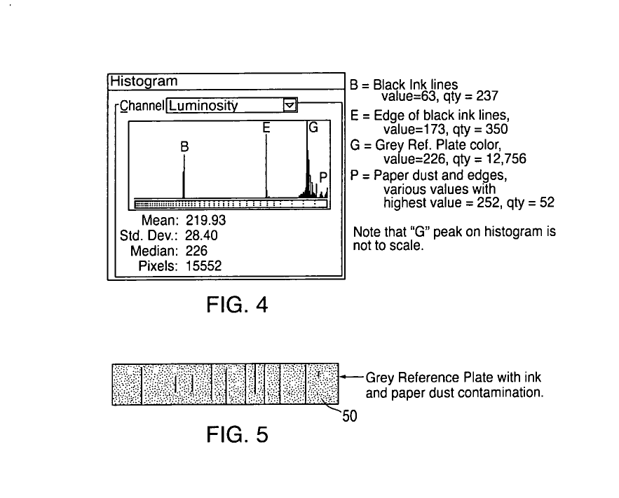

FIG. 4 depicts a histogram for determining the single grey response value. Results provided in FIG. 4, are indicative of grey reference plate 50 that has at least some amount of ink and paper dust contamination. The depiction includes the histogram of the pixel values for an image of the reference plate 50. Note that the peak representing the number of pixels 7 for the native grey color (having a grey scale value=226) of the reference plate 50 is substantially larger than other colors detected (12,756 pixels detecting the native grey). Other peaks in the histogram represent dark ink (having a grey scale value=63, pixels detecting=237); the edge of the dark ink (grey scale value=173, pixels detecting=350), and paper dust (various high grey scale values with the highest grey scale value of 252, with a quantity of pixels detecting=52). Note that the quantity of the native grey color pixels 7 is substantially larger than the quantity of other pixel colors, and therefore this algorithm is useful for ignoring the effect of reasonable quantities of contamination.

For on-going (routine) calibration to account for LED degradation and any other systematic or random changes, adjusting LED current 340 is typically performed each time the printer is powered on or at other regularly specified intervals. In typical embodiments, adjusting LED current 340 does not require use of the calibration document. Instead, the grey reference plate 50 (which may serve another purpose such as for holding the scan sheet 2 against the array of pixels 7 (or an intermediate structure, such as a glass overlay (not shown)) is used as the target for the purpose of setting the LED current. Note that if a scan sheet 2 is inserted in the printer 1 at power on, the scan sheet 2 must be ejected (moved away from the reference plate 50) before performing this operation.

An exemplary technique for performing routine LED adjustment calls for ensuring that the scan sheet 2 does not exist between the scanner 9 and the reference plate 50; setting the LED current to a minimum value; taking a sample for each pixel 7; saving the value and creating an operational LED adjustment value. Once the operational LED adjustment value is created (employing a desired algorithm), the result is compared to the initial LED adjustment value.

If the operational LED adjustment value is lower than the initial LED adjustment value, then the LED current is increased and then the sampling, saving and creating is repeated, and a revised operational LED adjustment value is created. This process is typically repeated until the initial LED adjustment value and the operational LED adjustment value are in substantial agreement (as defined by the user or manufacturer).

Similarly, if the operational LED adjustment value is higher than the initial LED adjustment value, then LED current setting is decreased and the process repeated, until such time as the initial LED adjustment value and the operational LED adjustment value are in substantial agreement (as defined by the user or manufacturer).

Typically, adjusting LED current 340 calls for keeping the operational LED adjustment value in substantial agreement with the initial LED adjustment value. However, in other embodiments, other relationships may be used. Once initial calibration of the printer 1 has been completed, adjusting LED current 340 may be executed automatically (for example, without a calibration document and human intervention). In some embodiments, adjusting LED current 340 may be manually initiated, such as after maintenance or cleaning.

An exemplary embodiment of a formula for calibration of each pixel(i) 7 is included below. In this example, the maximum response value of the video range data is defined as J_{wi}ref:
J_{wi}ref=Vᵣᵢ x (Wref/Tref) (1)
wherein:
Vᵣᵢ represents the video range of pixel(i) (from a calibration table);
Wref represents a representative response value for a white target; and,
Tref represents the calibration standard reflectivity (in percent).

At or above this video range value, the compensation process will saturate and assign a value of “FF” (as expressed in hexadecimal notation). The minimum response value of the video range data is defined as J_{Bi}ref:
J_{Bi}ref=Vᵣᵢ x(Bref/Tref) (2)
wherein:
Vᵣᵢ represents the video range of pixel(i) (from a calibration table);
Bref represents a representative response value for a black target; and,
Tref represents the calibration standard reflectivity (in percent).

At or below this video range value, the compensation process will saturate and assign a value of“00”(as expressed in hexadecimal notation).

In typical embodiments, a compensation table is maintained. The compensation table includes data for compensating the digitized video signal according to the value thereof. An exemplary calculation for compensated video values (V_{ci},M) is provided where for three regions in the compensation table for each pixel₍ᵢ₎:
V_{ci},M=((M−V_{bi})−J_{Bi}ref)×255/(J_{wi}ref−J_{Bi}ref) (3)
wherein:
M represents the raw video value (not the video range), before the black video value (V_{bi}), is subtracted; and
   the remaining variables are defined above in regard to equations 1 and 2.

Typically, the compensated video value, V_{ci},M, is positive eight bit integer which does not exceed a value of 255. The compensation table includes three regions, each region being determined by a value for the raw video value, M. The three regions for the raw video value M belong to one of a, b or c:
a. where (M−V_{bi})<=J_{Bi}ref in steps of 1, cell value=0;
b. where J_{Bi}ref<(M−V_{bi})<J_{wi}ref in steps of 1, cell value is V_{ci,}M; and,
c. where (M−V_{bi})>=J_{wi}ref in steps of 1, cell value=255.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for adjusting a light source, the method comprising:
selecting a scanning unit comprising at least one lighting element as the light source and a plurality of pixels for sensing the light source and further comprising a capability for adjusting an output of the at least one lighting element;
setting a minimum response value for at least one to all of the pixels when the at least one lighting element is set to a minimum output;
sampling a calibration standard for developing a representative response value for each pixel and adjusting the output of the at least one lighting element upward until at least one pixel reaches a maximum output during the sampling; and,
adjusting the output of the at least one lighting element downward until a subset of the at least one pixel is less than the maximum output during the sampling and then determining a maximum response value for each pixel.

2. The method as in claim 1, further comprising saving at least one of the minimum response value and the maximum response value for each pixel.

3. The method as in claim 1 further comprising scanning a reference plate and determining an initial response value for routine adjusting.

4. The method as in claim 1, wherein a relationship for the minimum response value comprises:
J_{Bi}ref=Vᵣᵢx(Bref/Tref)
wherein:
Vᵣᵢ represents the video range of pixel(s);
Bref represents a representative response value for a black target; and
Tref represents the calibration standard reflectivity.

5. The method as in claim 1, wherein a relationship for the maximum response value comprises:
J_{wi}ref=Vᵣᵢx(Wref/Tref)
wherein:
Vᵣᵢ represents the video range of pixel(s);
Wref represents a representative response value for a white target; and
Tref represents the calibration standard reflectivity.

6. The method as in claim 3, wherein routine adjusting comprises:
scanning the reference plate and determining an operational response value;
comparing the operational response value to the initial response value; and, alternatively,
one of adjusting the output of the at least one lighting element upward and downward and not adjusting the output of the at least one lighting element.

7. The method as in claim 3, wherein the reference plate comprises at least one of a grey reference plate and a plastic reference plate.

8. A computer program product stored on machine readable media and comprising instructions for adjusting a light source comprising at least one lighting element, by instructions comprising:
selecting a scanning unit comprising the at least one lighting element and a plurality of pixels and further comprising a capability for adjusting an output of the at least one lighting element;
setting a minimum response value for each pixel when the at least one lighting element is set to a minimum output;
sampling a calibration standard for developing a representative response value for each pixel and adjusting the output of the at least one lighting element upward until at least one pixel reaches a maximum output during the sampling; and,
adjusting the output of the at least one lighting element downward until a subset of the at least one pixel is less than the maximum output during the sampling and then setting a maximum response value for each pixel.

9. The computer program product as in claim 8, further comprising saving at least one of the minimum response value and the maximum response value for each pixel.

10. The computer program product as in claim 8, further comprising referencing a reference plate and determining an initial representative response value for routine adjusting.

11. The computer program product as in claim 10 wherein the determining comprises use of an algorithm.

12. The computer program product as in claim 8, further comprising instructions for maintaining a compensation table for each pixel, wherein a relationship for determining a compensation value for each pixel comprises:
V_{ci,}M=((M−V_{bi})−J_{Bi}ref)×255/(J_{wi}ref−J_{Bi}ref);
wherein
M represents a raw video value;
(V_{bi}) represents a black video value;
J_{Bi}ref represents the mimimum response value; and
J_{wi}ref represents the maximum response value.

13. The computer program product as in claim 10, wherein routine adjusting comprises:
scanning the reference plate and determining an operational representative response value;
comparing the operational representative response value to the initial representative response value; and, alternatively,
one of adjusting the output of the at least one lighting element upward and downward and not adjusting the output of the at least one lighting element.

14. The computer program product as in claim 10, wherein a relationship for the minimum response value comprises:
J_{Bi}ref=Vᵣᵢ x(Bref/Tref)
wherein:
Vᵣᵢ represents the video range of pixel₍ᵢ₎;
Bref represents a representative response value for a black target; and
Tref represents the calibration standard reflectivity.

15. The computer program product as in claim 10, wherein a relationship for the maximum response value comprises:
J_{wi}ref=Vᵣᵢ x(Wref/Tref)
wherein:
Vᵣᵢ represents the video range of pixel₍ᵢ₎;
Wref represents a representative response value for a white target; and
Tref represents the calibration standard reflectivity.

16. A scanner comprising a computer program product stored on machine readable media and comprising instructions for adjusting an internal light source comprising at least one lighting element, by instructions comprising:
setting a minimum response value for each pixel in a plurality of pixels when the at least one lighting element is set to a minimum output, the plurality of pixels for receiving output light from the at least one lighting element;
sampling a calibration standard for developing a representative response value for each pixel and adjusting the output of the at least one lighting element upward until at least one pixel reaches a maximum output during the sampling; and,
adjusting the output of the at least one lighting element downward until a subset of at least one pixel is less than the maximum output during the sampling and then setting a maximum response value for each pixel.

17. The scanner of claim 16 wherein the internal light source comprises an array of light emitting diodes.

18. The scanner of claim 16 wherein the plurality of pixels comprise at least one of a charge coupled device (CCD) and a complimentary metallized oxide semiconductor (CMOS).

19. The scanner of claim 16, further comprising at least one of an analog to digital converter, a processor and a memory.

20. The scanner of claim 16 comprised within one of a bed scanner, a scanning printer, a hand-held scanner, a point-of-sale device and a process device.
